(19) United States
(12) Patent Application Publication
(10) Pub. No.: US 2017/0331300 A1
(43) Pub. Date: Nov. 16, 2017

(54) SERVER APPARATUS AND CONTROL METHOD

(71) Applicant: Panasonic Intellectual Property Management Co., Ltd., Osaka (JP)

(72) Inventor: SHOICHI TOYA, Hyogo (JP)

(21) Appl. No.: 15/667,867

(22) Filed: Aug. 3, 2017

Related U.S. Application Data
(63) Continuation of application No. PCT/JP2016/088041, filed on Dec. 21, 2016.

(30) Foreign Application Priority Data
Feb. 24, 2016 (JP) 2016-033638

(51) Int. Cl. H02J 7/00; G06Q 30/02; H04W 4/26; H04L 29/08

(52) U.S. Cl. CPC H02J 7/0004; H04W 4/26; H04L 67/125; G06Q 30/0235; H02J 7/0047; H02J 2007/0098

(57) ABSTRACT

A server apparatus includes a communicator that communicates with a charging apparatus for a storage battery pack or an information terminal, and a controller. When the communicator acquires information indicating a status of the storage battery pack from the charging apparatus or the information terminal by a recommended deadline that is recommended to manage the status of the storage battery pack, compared to when the communicator does not acquire the information indicating the status of the storage battery pack by the recommended deadline, the controller makes an adjustment including at least one of discounting a usage fee for the storage battery pack, and increasing points which may be used to pay the usage fee by a user of the storage battery pack.

### BACKGROUND

### 1. Technical Field

The present disclosure relates to a server apparatus that communicates with an information terminal.

### 2. Description of the Related Art

In the past, technology such as systems and apparatus that lend out storage battery packs have been proposed. Examples of the above include the battery rental system server described in Japanese Unexamined Patent Application Publication No. 2011-118638, and the usage amount setting apparatus described in Japanese Unexamined Patent Application Publication No. 2013-232129.

### SUMMARY

However, a storage battery pack is not necessarily utilized appropriately all the time, and there is a possibility that a storage battery pack may be utilized inappropriately.

One non-limiting and exemplary embodiment provides a server apparatus and a control method enabling the support of appropriate utilization of a storage battery pack.

In one general aspect, the techniques disclosed here feature a server apparatus including a communicator that communicates with a charging apparatus for a storage battery pack or an information terminal, and a controller. When the communicator acquires information indicating a status of the storage battery pack from the charging apparatus or the information terminal by a recommended deadline that is recommended to manage the status of the storage battery pack, compared to when the communicator does not acquire the information indicating the status of the storage battery pack by the recommended deadline, the controller makes an adjustment including at least one of i) discounting a usage fee for the storage battery pack, and ii) increasing points which may be used to pay the usage fee by a user of the storage battery pack.

It should be noted that general or specific embodiments may be implemented as a system, an apparatus, a method, an integrated circuit, a computer program, or a non-transitory computer-readable recording medium such as a CD-ROM disc, or any selective combination thereof.

According to a server apparatus according to an aspect of the present disclosure, appropriate utilization of a storage battery pack is supported.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic diagram of a storage battery management system according to an embodiment;

FIG. 2 is a block diagram illustrating a configuration of a storage battery management system according to an embodiment;

FIG. 3 is a sequence diagram of operation of a storage battery management system;

FIG. 4 is a diagram illustrating an adjustment process conducted in accordance with a determination result regarding a recommended deadline;

FIG. 5 is a diagram illustrating an example of a notification image displayed on a display of an information terminal on the basis of notification information in a case of a determination result indicating compliance;

FIG. 6 is a diagram illustrating an example of a notification image displayed on a display of an information terminal on the basis of notification information in a case of a determination result indicating violation; and

FIG. 7 is a diagram illustrating an example of a recommendation image displayed on a display of an information terminal on the basis of recommendation information.

### DETAILED DESCRIPTION

### (Underlying Knowledge Forming Basis of the Present Disclosure)

With regard to the utilization of a storage battery pack, the inventor discovered problems through investigation. Hereinafter, these problems will be described specifically.

In recent years, electronic equipment using storage battery packs have become commonplace. One such example is an electric power-assisted bicycle. For example, the user of a piece of electronic equipment purchases a storage battery pack used with the electronic equipment, and causes the electronic equipment to operate by using the purchased storage battery pack. Recently, investigation has also begun with regard to storage battery pack lending systems, which enable a user of a piece of electronic equipment to borrow a storage battery pack to use with the electronic equipment, and cause the electronic equipment to operate by using the borrowed storage battery pack.

For example, in such a lending system, the user, that is, the borrower of the storage battery pack, is able to utilize a lent storage battery pack within the scope of a certain usage amount or a certain usage period. On the other hand, utilization of the storage battery pack that exceeds the scope of the certain usage amount or the certain usage period is prohibited. Accordingly, the user returns the storage battery pack in accordance with the scope of the certain usage amount or the certain usage period, for example. Additionally, to cause a piece of electronic equipment to operate, the user newly borrows the returned storage battery pack, or a different storage battery pack.

The procedure for newly borrowing a storage battery pack specifically is conducted at a service center where storage battery packs are lent out. Thus, basically, the work of the user going to the service center in accordance with the scope of the certain usage amount or the certain usage period is produced. To reduce or eliminate this work, a procedure for enabling continued utilization of a lent storage battery pack by the user may also be conducted over a communication network. With this arrangement, the work of going to the service center is reduced or eliminated.

However, there is a possibility that a lent storage battery pack may be utilized inappropriately. Furthermore, by conducting a procedure for enabling continued utilization of a lent storage battery pack over a communication network, there is a possibility that the lent storage battery pack may continue to be utilized inappropriately.

Accordingly, a server apparatus according to one aspect of the present disclosure includes a communicator that communicates with a charging apparatus for a storage battery pack or an information terminal, and a controller, wherein when the communicator acquires information indicating a status of the storage battery pack from the charging apparatus or the information terminal by a recommended deadline that is recommended to manage the status of the storage battery pack, compared to when the communicator does not acquire the information indicating the status of the storage battery pack by the recommended deadline, the controller makes an adjustment including at least one of i) discounting a usage fee for the storage battery pack, and ii) increasing points which may be used to pay the usage fee by a user of the storage battery pack.

For this reason, an incentive may be conferred to a user who has caused a charging apparatus or an information terminal to transmit information indicating the status of the storage battery pack to a communication device of a server apparatus by a recommended deadline, thereby encouraging the user to cause such information to be transmitted to the communication device by a recommended deadline. Thus, the server apparatus is able to support appropriate utilization of the storage battery pack by the user.

Also, when the communicator acquires the information indicating the status of the storage battery pack by the recommended deadline, the controller may decrease the usage fee.

For this reason, an incentive may be conferred to a user who has caused information indicating the status of the storage battery pack to be transmitted to the communication device by the recommended deadline.

Also, when the communicator does not acquire the information indicating the status of the storage battery pack by the recommended deadline, the controller may increase the usage fee.

For this reason, a penalty may be conferred to a user who has not caused information indicating the status of the storage battery pack to be transmitted to the communication device by the recommended deadline.

Also, when the communicator acquires the information indicating the status of the storage battery pack by the recommended deadline, the controller may confer the points.

For this reason, an incentive may be conferred to a user who has caused information indicating the status of the storage battery pack to be transmitted to the communication device by the recommended deadline.

Also, when the communicator does not acquire the information indicating the status of the storage battery pack by the recommended deadline, the controller may reduce the points.

For this reason, a penalty may be conferred to a user who has not caused information indicating the status of the storage battery pack to be transmitted to the communication device by the recommended deadline.

Also, the controller may transmit information indicating the recommended deadline to the charging apparatus via the communicator.

For this reason, the user may be informed of the recommended deadline easily.

Also the controller may transmit, to the information terminal of the user of the storage battery pack via the communicator, information encouraging the user to transmit the information indicating the status of the storage battery pack to the server apparatus.

For this reason, a user may be encouraged to cause information indicating the status of the storage battery pack to be transmitted to the communication device by the recommended deadline easily.

Note that these general or specific aspects may also be realized by a system, an apparatus, a method, an integrated circuit, a computer program, or a non-transitory computer-readable recording medium such as a CD-ROM disc, or any selective combination thereof.

Hereinafter, embodiments will be described specifically with reference to the drawings. Note that the exemplary embodiments described hereinafter all illustrate general or specific examples. Features such as numerical values, shapes, materials, structural elements, layout positions and connection states of structural elements, steps, and the ordering of steps indicated in the following exemplary embodiments are merely examples, and are not intended to limit the present disclosure. In addition, among the structural elements in the following exemplary embodiments, structural elements that are not described in the independent claim indicating the broadest concept are described as arbitrary or optional structural elements.

Also, in the following description, charge-discharge means at least one of electrical charging and electrical discharging. Also, usage of a storage battery pack may refer to the charging of the storage battery pack or the discharging of the storage battery pack. Also, utilization of a storage battery pack may refer to usage of the storage battery pack. Also, utilization availability of a storage battery pack may correspond to whether utilization of the storage battery pack is permitted or denied. For example, making utilization available may correspond to permitting utilization, whereas making utilization unavailable may correspond to prohibiting utilization.

### Embodiments

### [Overall Configuration]

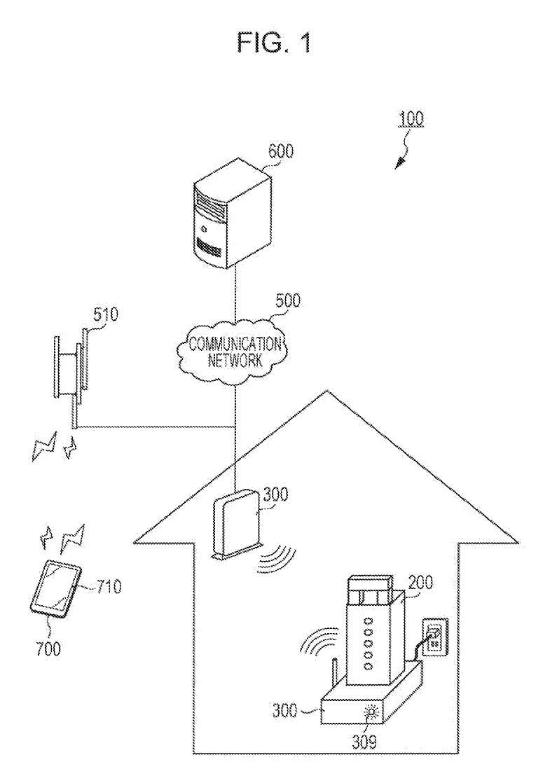

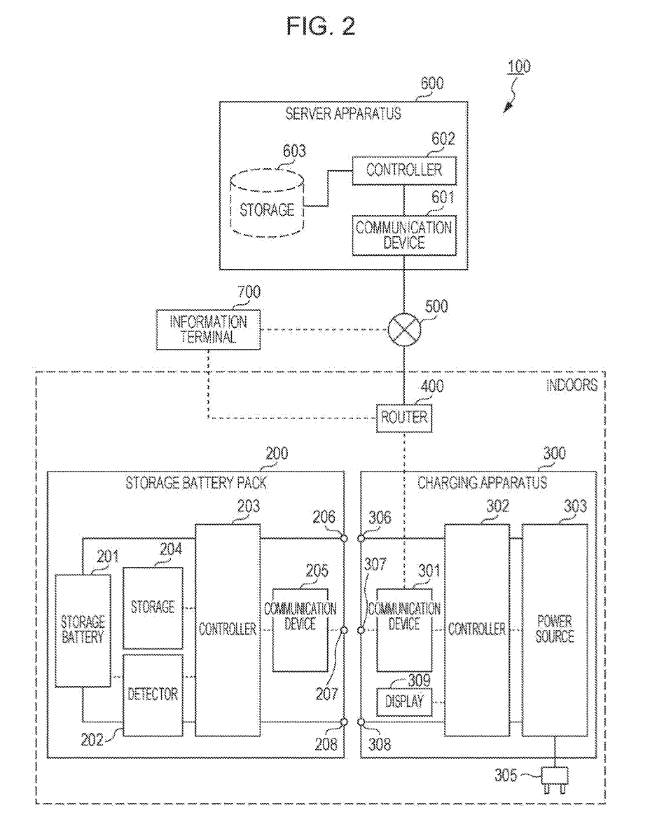

FIG. 1 is a schematic diagram of a storage battery management system according to an embodiment. FIG. 2 is a block diagram illustrating a configuration of a storage battery management system according to an embodiment. Specifically, FIGS. 1 and 2 illustrate a storage battery pack 200, a charging apparatus 300, a router 400, a communication network 500, a server apparatus 600, and an information terminal 700. For example, the storage battery management system 100 is provided with the storage battery pack 200, the charging apparatus 300, and the server apparatus 600 from among these structural elements.

The storage battery management system 100 is a system for managing the storage battery pack 200. The storage battery management system 100 is utilized as a lending system for the storage battery pack 200 and the charging apparatus 300, for example. In the following embodiments, the storage battery pack 200 and the charging apparatus 300 are described as being lent to a user.

### [Storage Battery Pack]

First, the storage battery pack 200 will be described. The storage battery pack 200 is an apparatus subjected to charging and discharging, and is an apparatus for storing electrical energy. For example, the storage battery pack 200 is lent out to a user from a lending business, and is removably connected to electrical equipment, such as an electric power-assisted bicycle. Subsequently, the electrical equipment connected to the storage battery pack 200 operates on power obtained by the discharging of the storage battery pack 200. Also, the storage battery pack 200 is removably connected to the charging apparatus 300.

Additionally, the storage battery pack 200 is provided with a storage battery 201, a detector 202, a controller 203, storage 204, a communication device 205, a power terminal 206, a communication terminal 207, and a power terminal 208.

The storage battery 201 is a structural element for storing electrical energy, and is also called a secondary battery or a rechargeable battery. The storage battery 201 may be made up of a single unit battery (cell, unit cell, battery block), or may be made up of multiple unit batteries.

The detector 202 is a structural element for detecting the status of the storage battery 201. For example, the detector 202 detects properties such as the voltage and the temperature of the storage battery 201. Additionally, the detector 202 may also detect the internal resistance of the storage battery 201. Also, the detector 202 detects properties such as the magnitude of an impact force imparted to the storage battery pack 200, and the number of times an impact force has been imparted. Specifically, the detector 202 is made up of components such as a voltmeter, a thermometer, and an impact sensor, for example.

The controller 203 is a structural element for controlling the operation of the storage battery pack 200. For example, the controller 203 controls charging and discharging of the storage battery 201. Also, the controller 203 stores, in the storage 204, information such as the voltage and the temperature of the storage battery 201, the magnitude of an impact force imparted to the storage battery pack 200, and the number of times an impact force has been imparted as detected by the detector 202. Factors such as the voltage and the internal resistance of the storage battery 201 are stored as information indicating the status of the storage battery pack 200 (status information), for example. The temperature of the storage battery 201 is stored as temperature information, for example. The magnitude of an impact force imparted to the storage battery pack 200 and the number of times an impact force has been imparted are stored as impact-related information. The magnitude of an impact force is an example of a value related to impact force. Note that the status information of the storage battery pack 200 may also include temperature information, impact-related information, and the like.

Additionally, the controller 203 communicates with the charging apparatus 300 by controlling the communication device 205. Specifically, when the storage battery pack 200 is connected to the charging apparatus 300, the controller 203 transmits information stored in the storage 204 to the charging apparatus 300 using the communication device 205. Whether or not the storage battery pack 200 is connected to the charging apparatus 300 is detectable on the basis of whether or not the communication device 205 has received a notification from a communication device 301 of the charging apparatus 300 via the communication terminal 207, or the like.

Specifically, the controller 203 is realized by a component such as a processor, a microcontroller, or a special-purpose circuit, but it is sufficient for such a component to be provided with control functions. For example, the controller 203 may be provided with a computational processor (not illustrated) and storage (not illustrated) that stores a control program. Examples of the computational processor include an MPU and a CPU. Examples of the storage include memory. The controller 203 may also be made up of a lone controller that performs centralized control, or may be made up of multiple controllers that cooperate with each other to perform decentralized control.

The storage 204 stores an ID of the storage battery pack 200, as well as information such as the status information, temperature information, and impact-related information of the storage battery pack 200. Specifically, the storage 204 is semiconductor memory such as electrically erasable programmable read-only memory (EEPROM), and when storage is included in the controller 203, the storage 204 may be realized by the storage included in the controller 203.

The communication device 205 is a structural element for communicating with the charging apparatus 300. Specifically, the communication device 205 is a component such as a communication circuit or a communication module. The communication terminal 207 may also be included in the communication device 205.

Specifically, when the storage battery pack 200 is connected to the charging apparatus 300, the communication device 205, on the basis of control by the controller 203, transmits information stored in the storage 204 to the communication device 301 of the charging apparatus 300. Communication between the communication device 205 and the communication device 301 provided in the charging apparatus 300 is conducted in a state in which the communication terminal 207 and the communication terminal 307 provided in the charging apparatus 300 are connected. The method of communication between the communication device 205 and the communication device 301 is not particularly limited.

The communication terminal 207 is a communication terminal that is electrically or mechanically connected to a communication terminal 307 of the charging apparatus 300 that charges the storage battery pack 200. The communication terminal 207 may also be electrically or mechanically connected to electrical equipment that consumes power discharged from the storage battery pack 200.

Each of the power terminal 206 and the power terminal 208 is a power terminal that is electrically or mechanically connected to the charging apparatus 300 that charges the storage battery pack 200. The power terminal 206 is connected to a power terminal 306 of the charging apparatus 300, while the power terminal 208 is connected to a power terminal 308 of the charging apparatus 300. Each of the power terminal 206 and the power terminal 208 may also be connected to electrical equipment that consumes power discharged from the storage battery pack 200. The charging and discharging of the storage battery 201 is conducted in a state in which the power terminal 206 is connected to the power terminal 306, and the power terminal 208 is connected to the power terminal 308.

Specifically, one of the power terminal 206 and the power terminal 208 is a plus power terminal, while the other is a minus power terminal. For example, the power terminal 206 may be the plus power terminal, while the power terminal 208 may be the minus power terminal.

### [Charging Apparatus]

Next, the charging apparatus 300 will be described. The charging apparatus 300 is an apparatus that charges the storage battery pack 200. For example, the charging apparatus 300 is lent out to a user from the lending business of the storage battery pack 200, and is utilized by the user to charge the storage battery pack 200. The charging apparatus 300 may be configured to be able to charge only one storage battery pack 200, or to be able to charge multiple storage battery packs 200 at the same time. The charging apparatus 300 is provided with a communication device 301, a controller 302, a power source 303, a plug 305, a power terminal 306, a communication terminal 307, and a power terminal 308.

The communication device 301 is a structural element for communicating with the storage battery pack 200, the server apparatus 600, and the like. Specifically, the communication device 301 is a component such as a communication circuit or a communication module. The communication terminal 307 may also be included in the communication device 301.

First, communication between the communication device 301 and the storage battery pack 200 will be described.

When the storage battery pack 200 is connected to the charging apparatus 300, the communication device 301 communicates with the storage battery pack 200. Specifically, the communication device 301 communicates with the communication device 205 in a state in which the communication terminal 207 of the storage battery pack 200 is connected to the communication terminal 307 of the charging apparatus 300. In the communication between the communication device 301 and the communication device 205, the communication device 301 receives information stored in the storage 204 of the storage battery pack 200.

Next, communication between the communication device 301 and the server apparatus 600 will be described.

For example, the communication device 301 communicates with the server apparatus 600 over the communication network 500 or the like. The communication device 301 may communicate with the server apparatus 600 via the router 400 and the communication network 500, or may communicate with the server apparatus 600 via the information terminal 700 and the communication network 500. The communication between the communication device 301 and the router 400 may be wireless communication or wired communication, for example.

For example, the communication device 301 transmits information indicating the utilization conditions of the storage battery pack 200 to the server apparatus 600 via the communication network 500 or the like. Note that the information indicating the utilization conditions of the storage battery pack 200 is information stored in the storage 204 of the storage battery pack 200, and specifically is information such as the status information, temperature information, and impact-related information of the storage battery pack 200. Additionally, the communication device 301 may also receive information indicating a recommended deadline (deadline information) from the server apparatus 600 via the communication network 500 or the like.

The communication terminal 307 is a communication terminal that is electrically or mechanically connected to the communication terminal 207 of the storage battery pack 200.

Each of the power terminal 306 and the power terminal 308 is a power terminal that is electrically or mechanically connected to the storage battery pack 200. The power terminal 306 is connected to the power terminal 206, while the power terminal 308 is connected to the power terminal 208. The charging and discharging of the storage battery 201 is conducted in a state in which the power terminal 306 is connected to the power terminal 206, and the power terminal 308 is connected to the power terminal 208.

One of the power terminal 306 and the power terminal 308 is a plus power terminal, while the other is a minus power terminal. For example, the power terminal 306 may be the plus power terminal, while the power terminal 308 may be the minus power terminal.

When deadline information is received in the communication device 301, the controller 302 determines whether or not the period until the recommended deadline indicated by the deadline information is less than a certain period (for example, less than 5 days). If the controller 302 determines that the period until the recommended deadline is less than the certain period, the controller 302 judges that the recommended deadline is close, and causes a display 309 to present a display indicating that the recommended deadline is close.

The controller 302 is a structural element that controls the communication device 301, controls charging of the storage battery pack 200, and the like. Specifically, the controller 302 is realized by a component such as a processor, a microcontroller, or a special-purpose circuit, but it is sufficient for such a component to be provided with control functions. For example, the controller 302 may be provided with a computational processor (not illustrated) and storage (not illustrated) that stores a control program. Examples of the computational processor include an MPU and a CPU. Examples of the storage include memory. The controller 302 may also be made up of a lone controller that performs centralized control, or may be made up of multiple controllers that cooperate with each other to perform decentralized control.

The power source 303 is a structural element used to charge the storage battery pack 200. The power source 303 includes a charging circuit that charges the storage battery pack 200 connected to the charging apparatus 300, using electric power supplied from an external power source such as a power grid. Specifically, the power source 303 converts alternating current (AC) power supplied from the power grid via the plug 305 into direct current (DC) power suitable for charging the storage battery pack 200. The power source 303 is realized by components such as an AC/DC converter, a DC/AC inverter, and a DC/DC converter, for example.

The plug 305 is one example of a power receiver, and is a structural element that is removably connected to a power supplier such as a power outlet or socket.

The display 309 presents a display indicating that the recommended deadline is close. The display 309 is made up of a light source such as LEDs capable of expressing RGB, and present the display by turning on the red color, for example. Note that the display 309 may also be made up of a light source such as a single-color LED, and present the display by turning on the single-color LED. The turning on in this case also includes turning on by blinking or flashing.

### [Router]

The router 400 is an apparatus for relaying communication. The router 400 is able to communicate with the charging apparatus 300. The router 400 is able to communicate with the server apparatus 600 over a communication network 500 such as the Internet. Additionally, by communicating with the charging apparatus 300 and also communicating with the server apparatus 600 over the communication network 500, the router 400 relays communication between the charging apparatus 300 and the server apparatus 600. For example, the router 400 conducts wireless communication with the charging apparatus 300, and conducts wired communication with the server apparatus 600.

In addition, the router 400 is also able to communicate with the information terminal 700. For example, the router 400 conducts wireless communication with the information terminal 700.

### [Communication Network]

The communication network 500 is a communication network by which the charging apparatus 300, the router 400, the server apparatus 600, and the information terminal 700 communicate with each other. The communication network 500 may be a general-purpose network such as the Internet, or a special-purpose network for the storage battery management system 100.

### [Server Apparatus]

The server apparatus 600 is a server apparatus for supporting appropriate utilization of the storage battery pack 200. The server apparatus 600 may be an information processing apparatus such as a computer. Additionally, the server apparatus 600 may also be made up of multiple apparatuses.

Specifically, the server apparatus 600 is provided with a communication unit 601, a controller 602, and storage 603. Note that the storage 603 may also not be a structural element of the server apparatus 600, and instead may be provided in another piece of equipment communicably connected to the server apparatus 600.

The communication unit 601 is a structural element for communicating with the charging apparatus 300 and the information terminal 700. Specifically, the communication device 601 is a component such as a communication circuit or a communication module.

The communication unit 601 communicates with the router 400 over a communication network 500 such as the Internet. Additionally, the communication unit 601 communicates with the charging apparatus 300 via the router 400 or the like. The communication between the communication device 601 and the router 400 may be wired communication or wireless communication, for example. Additionally, the communication unit 601 may also communicate with the charging apparatus 300 directly, without going through the router 400 or the like.

Specifically, the communication unit 601 receives, over the communication network 500, information indicating the utilization conditions of the storage battery pack 200 from the charging apparatus 300 that charges the storage battery pack 200. The communication unit 601 may also receive the information indicating the utilization conditions from the information terminal 700 over the communication network 500.

Meanwhile, the communication unit 601 is also able to communicate with the information terminal 700. Communication between the communication unit 601 and the information terminal 700 includes wireless communication. For the wireless communication, a communication standard utilized in a mobile communication system such as a 3rd Generation (3G) mobile communication system, a 4th Generation (4G) mobile communication system, or LTE (registered trademark) is used.

Specifically, the communication unit 601 transmits notification information, which indicates the result of an adjustment process (to be described later) conducted by the controller 602 using the utilization conditions of the storage battery pack 200, to the information terminal 700 possessed by the user of the storage battery pack 200. Additionally, the communication unit 601 may also transmit recommendation information, which encourages the user to transmit status information of the storage battery pack 200 to the server apparatus 600, to the information terminal 700 possessed by the user of the storage battery pack 200. Additionally, the communication unit 601 may also transmit information indicating the recommended deadline (deadline information) to the charging apparatus 300.

The controller 602 determines whether or not the status information of the storage battery pack 200 has been acquired from the charging apparatus 300 or the information terminal 700 via the communication unit 601 by the recommended deadline which is recommended in order to manage the status of the storage battery pack 200. Additionally, when the status information is acquired by the recommended deadline, the controller 602 makes an adjustment (conducts an adjustment process) involving at least one of lowering the usage fee of the storage battery pack 200 and increasing an amount of points which may be used to pay the usage fee by the user of the storage battery pack 200, compared to when the status information is not acquired. The recommended deadline may be, for example, a period from when status information was acquired last time until a day after a certain period of time (for example, one month), or a period until a day predetermined for each of a certain period of time (such as one day each month, for example).

The controller 602 may also transmit notification information or recommendation information to the information terminal 700 possessed by the user of the storage battery pack 200 via the communication unit 601. Additionally, the controller 602 may also transmit deadline information to the charging apparatus 300 via the communication unit 601.

Specifically, the controller 602 is realized by a component such as a processor, a microcontroller, or a special-purpose circuit, but it is sufficient for such a component to be provided with control functions. For example, the controller 602 may be provided with a computational processor (not illustrated) and storage (not illustrated) that stores a control program. Examples of the computational processor include an MPU and a CPU. Examples of the storage include memory. The controller 602 may also be made up of a lone controller that performs centralized control, or may be made up of multiple controllers 602 that cooperate with each other to perform decentralized control.

The 603 stores the recommended deadline. Also, the storage 603 stores information indicating the utilization conditions of the storage battery pack 200 received via the communication unit 601. Also, the storage 603 stores the result of the adjustment process by the controller 602. The storage of information indicating the utilization conditions of the storage battery pack 200 in the storage 603 and the updating of such information, as well as the storage of the result of the adjustment process by the controller 602 in the storage 603 and the updating of such a result, are conducted by the controller 602.

Specifically, the storage 603 is semiconductor memory such as electrically erasable programmable read-only memory (EEPROM), or a hard disk drive (HDD) or the like. When storage is included in the controller 602, the storage 603 may also be realized as such storage. Additionally, the storage 603 may also be realized as a storage apparatus separate from the server apparatus 600,

### [Information Terminal]

The information terminal 700 is an apparatus that communicates with the server apparatus 600 over the communication network 500 through a communication connection with the router 400, or through a communication connection with a base station 510 of a mobile communication system. Specifically, the information terminal 700 is an information terminal possessed by the user of the storage battery pack 200. The information terminal 700 may be an information processing apparatus such as a computer, or a mobile terminal such as a smartphone or tablet. For this communication, wired communication may be applied, or wireless communication may be applied.

For example, for the communication connection between the information terminal 700 and the base station 510 of the mobile communication system, a communication standard utilized in a mobile communication system such as a 3rd Generation (3G) mobile communication system, a 4th Generation (4G) mobile communication system, or LTE (registered trademark) is used, for example,

In addition, the communication connection between the information terminal 700 and the router 400 may be conducted in a wireless manner, or may be conducted in a wired manner. Note that the information terminal 700 may also relay communication between the charging apparatus 300 and the server apparatus 600, instead of the router 400.

The information terminal 700 receives notification information indicating the result of the adjustment process from the server apparatus 600. In addition, the information terminal 700 receives, from the server apparatus 600, recommendation information encouraging the user to transmit the status information of the storage battery pack 200 to the server apparatus 600. The notification information and the recommendation information is display information for displaying a notification image and a recommendation image, respectively. The information terminal 700 may receive notification information or recommendation information directly from the server apparatus 600, or may receive notification information or recommendation information via the communication network 500 and the router 400.

In Embodiment 1, the information terminal 700 includes a display 710. On the display 710, there is displayed a notification image indicating an incentive or a penalty conferred to the user, on the basis of notification information transmitted from the server apparatus 600. Also, on the display 710, there is displayed a recommendation image including a message encouraging the user to transmit the status information of the storage battery pack 200 to the server apparatus 600, on the basis of recommendation information transmitted from the server apparatus 600.

### [Overall Operation]

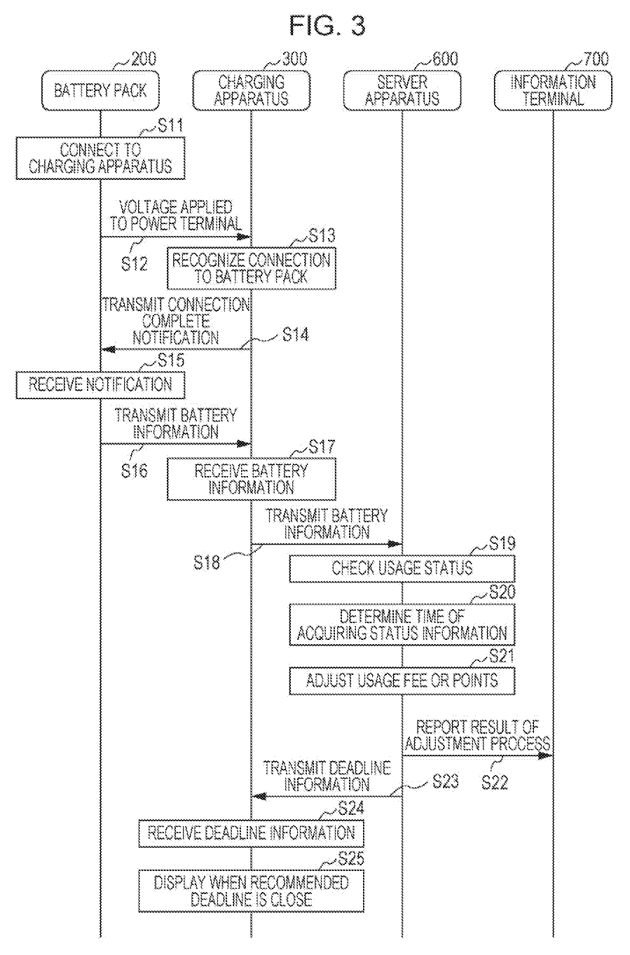

Next, the operation of the storage battery management system 100 will be described. FIG. 3 is a sequence diagram of the operation of the storage battery management system 100.

First, the storage battery pack 200 is connected to the charging apparatus 300 by the user (S11). Specifically, the power terminal 206 is connected to the power terminal 306, the communication terminal 207 to the communication terminal 307, and the power terminal 208 to the power terminal 308. By doing so, in the charging apparatus 300, a voltage is applied between the power terminal 306 and the power terminal 308 (S12).

The controller 302 of the charging apparatus 300 detects the voltage applied between the power terminal 306 and the power terminal 308, and thereby recognizes that the storage battery pack 200 is connected (S13). The controller 302, upon recognizing that the storage battery pack 200 is connected, causes the communication device 301 to transmit a notification indicating that the connection of the storage battery pack 200 is complete (S14). This notification is transmitted to the communication device 205 of the storage battery pack 200.

After the communication device 205 of the storage battery pack 200 receives the notification (S15), the controller 203 causes the communication device 205 to transmit battery information about the storage battery pack 200 (S16). It is sufficient for the battery information to include at least an ID of the storage battery pack 200. The battery information may also include information such as temperature information and impact-related information, and in cases in which such information is required as the information indicating the utilization conditions of the storage battery pack 200 in step S20, such information may be included in the battery information.

The communication device 301 of the charging apparatus 300 receives battery information from the communication device 205 of the storage battery pack 200 (S17), and transmits the received battery information to the communication unit 601 of the server apparatus 600 (S18).

After the communication unit 601 of the server apparatus 600 receives battery information from the communication device 301 of the charging apparatus 300, the controller 602 checks the information indicating the utilization conditions stored in the storage 603, or in other words, the utilization conditions of the storage battery pack 200 (S19). If the battery information includes information indicating the utilization conditions of the storage battery pack 200, such as status information, temperature information, and impact-related information, the controller 602 updates the status information of the storage battery pack 200 stored in the storage 603. Specifically, if the battery information includes information indicating the utilization conditions of the storage battery pack 200, the controller 602 updates the status information stored in the storage 603 in association with the ID of the storage battery pack 200.

Subsequently, the controller 602 determines whether or not the status information of the storage battery pack 200 having the ID included in the battery information has been acquired from the charging apparatus 300 or the information terminal 700 via the communication unit 601 by the recommended deadline which is recommended in order to manage the status of the storage battery pack 200 (S20). Specifically, the controller 602 determines whether or not the time when status information associated with the ID included in the battery information was last acquired has been acquired by the recommended deadline.

Next, in accordance with the result of the determination, the controller 602 adjusts (conducts an adjustment process with respect to) the usage fee of the storage battery pack 200 and the points which may be used to pay the usage fee by the user of the storage battery pack 200 (S21). With this arrangement, the controller 602 confers an incentive or a penalty to the user of the storage battery pack 200.

Next, the controller 602 causes the communication unit 601 to transmit notification information indicating the result of the adjustment process to the information terminal 700 (S22). Note that the controller 602 may also not transmit notification information to the information terminal 700 in step S22.

Also, after step S21, the controller 602 transmits information indicating the recommended deadline to the charging apparatus 300 via the communication unit 601 (S23).

The communication device 301 of the charging apparatus 300 receives the information indicating the recommended deadline from the communication unit 601 (S24). Subsequently, after the deadline information is received in the communication device 301, the controller 302 of the charging apparatus 300 determines whether or not the period until the recommended deadline indicated by the deadline information is less than a certain period (for example, less than 5 days). If the controller 302 determines that the period until the recommended deadline is less than the certain period, the controller 302 judges that the recommended deadline is close, and causes the display 309 to present a display indicating that the recommended deadline is close, as illustrated in FIG. 1, for example (S25).

Note that the determination of whether or not the period until the recommended deadline is less than the certain period may also be conducted in the server apparatus 600. In this case, instead of transmitting deadline information in step S23, the server apparatus 600 transmits information causing the charging apparatus 300 to present a display indicating that the recommended deadline is close only if the period until the recommended deadline is less than the certain period. The charging apparatus 300 receives the information for presenting a display indicating that the recommended deadline is close, and causes the display 309 to present the display.

Additionally, instead of transmitting deadline information to the charging apparatus 300, the server apparatus 600 may also transmit recommendation information to the information terminal 700. Specifically, after step S21, the controller 602 of the server apparatus 600 may transmit, via the communication unit 601, recommendation information to the information terminal 700 possessed by the user of the storage battery pack 200. Note that the controller 602 may also transmit the recommendation information to the information terminal 700 only when the recommended deadline is close, such as during a certain period (5 days) before the recommended deadline, for example.

### [Adjustment Process]

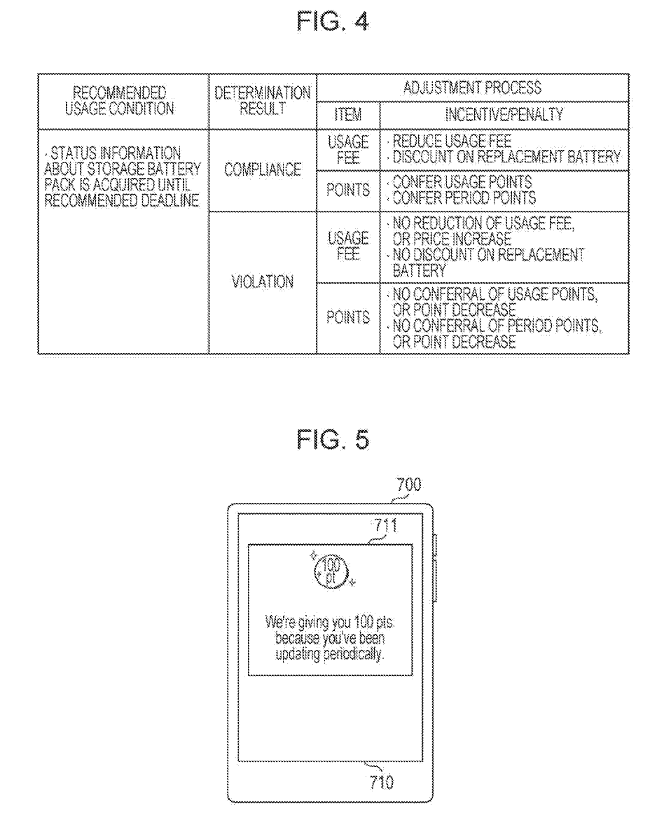

Next, the adjustment process conducted by the controller 602 after the determination of the recommended deadline will be described specifically using FIG. 4. FIG. 4 is a diagram illustrating an adjustment process conducted in accordance with a determination result regarding a recommended deadline.

In the adjustment process, when status information about the storage battery pack 200 is acquired by the recommended deadline (if the determination result is “compliance”), the controller 602 may make an adjustment to reduce the usage fee of the storage battery pack 200. For example, in the adjustment process, the controller 602 may reduce a monthly lending fee on the storage battery pack 200, reduce the cost of a new, different storage battery pack 200 (equipment cost) when replacing the storage battery pack 200, or reduce the cost of a different storage battery pack 200 (equipment cost) when the user of the storage battery pack 200 additionally borrows a different storage battery pack 200.

Conversely, in the adjustment process, when status information about the storage battery pack 200 is not acquired by the recommended deadline (if the determination result is “violation”), the controller 602 may make an adjustment to increase the usage fee. For example, in the adjustment process, the controller 602 may increase a monthly lending fee on the storage battery pack 200, increase the cost of a new, different storage battery pack 200 (equipment cost) when replacing the storage battery pack 200, or increase the cost of a different storage battery pack 200 (equipment cost) when the user of the storage battery pack 200 additionally borrows a different storage battery pack 200.

Also, in the adjustment process, the controller 602 may not only adjust the usage fee, but may also adjust points.

In the adjustment process, when status information about the storage battery pack 200 is acquired by the recommended deadline (if the determination result is “compliance”), the controller 602 may confer points which may be used to pay the usage fee to the user of the storage battery pack 200. For example, in the adjustment process, the controller 602 may confer, to the user, usage points which may be used to pay the next monthly lending fee, or period points which may be used to extend a predetermined lending period of the storage battery pack 200. In other words, the points referred to herein are points which may be used by the user to pay the lending fee of the storage battery pack 200, to pay for a replacement battery, to extend the lending period of a storage battery pack, or the like.

Conversely, in the adjustment process, when status information about the storage battery pack 200 is not acquired by the recommended deadline (if the determination result is “violation”), the controller 602 may deduct points associated with the user of the storage battery pack 200. For example, in the adjustment process, the controller 602 may deduct usage points which may be used by the user to pay the next monthly lending fee, or period points which may be used to extend a predetermined lending period of the storage battery pack 200.

Note that in the case of a system in which the controller 602 decreases the usage fee or confers points when status information about the storage battery pack 200 is acquired by the recommended deadline, the controller 602 may also not conduct an adjustment process of increasing the usage fee or deducting points when status information about the storage battery pack 200 is not acquired by the recommended deadline. Also, conversely, in the case of a system in which the controller 602 increases the usage fee or deducts points when status information about the storage battery pack 200 is not acquired by the recommended deadline, the controller 602 may also not conduct an adjustment process of decreasing the usage fee or adding points when status information about the storage battery pack 200 is acquired by the recommended deadline.

### [Notification Information and Recommendation Information]

Next, the notification information and the recommendation information transmitted from the server apparatus 600 to the information terminal 700 will be described specifically using FIGS. 5 to 7.

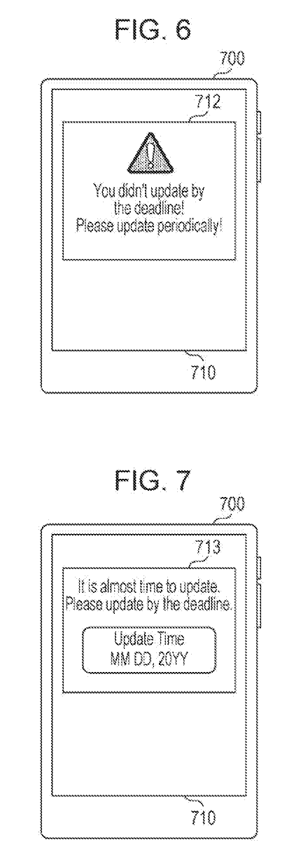

FIG. 5 is a diagram illustrating an example of a notification image displayed on a display of an information terminal on the basis of notification information in a case of a determination result indicating compliance. FIG. 6 is a diagram illustrating an example of a notification image displayed on a display of an information terminal on the basis of notification information in a case of a determination result indicating violation.

In the server apparatus 600, if the controller 602 determines that status information about the storage battery pack 200 has been acquired by the recommended deadline, notification information indicating the determination result is transmitted to the information terminal 700 possessed by the user of the storage battery pack 200. Subsequently, as illustrated in FIG. 5, a notification image 711 indicating that 100 points have been conferred to the user of the storage battery pack 200 as an incentive is displayed on the display 710 of the information terminal 700 on the basis of the notification information. In this way, by looking at the notification image 711, the user is able to know that he or she successfully transmitted status information by the recommended deadline. For this reason, the server apparatus 600 is able to effectively encourage the user to transmit status information about the storage battery pack 200 to the server apparatus 600 by the recommended deadline.

Also, in the server apparatus 600, if the controller 602 determines that status information about the storage battery pack 200 has not been acquired by the recommended deadline, notification information indicating the determination result is transmitted to the information terminal 700 possessed by the user of the storage battery pack 200. Subsequently, as illustrated in FIG. 6, a notification image 712 indicating that the server apparatus 600 has not acquired status information about the storage battery pack 200 by the recommended deadline is displayed on the display 710 of the information terminal 700. In this way, by looking at the notification image 712, the user is able to know that he or she did not successfully transmit status information by the recommended deadline. For this reason, the server apparatus 600 is able to effectively encourage the user to transmit status information about the storage battery pack 200 to the server apparatus 600 by the recommended deadline.

Next, the case in which the server apparatus 600 transmits recommendation information to the information terminal 700 instead of transmitting deadline information to the charging apparatus 300 will be described. FIG. 7 is a diagram illustrating an example of a recommendation image displayed on a display of an information terminal on the basis of recommendation information.

If the server apparatus 600 determines that the recommended deadline is close, recommendation information is transmitted to the information terminal 700 possessed by the user of the storage battery pack 200. Subsequently, as illustrated in FIG. 7, a recommendation image 713 encouraging the user to transmit status information about the storage battery pack 200 to the server apparatus 600 by the recommended deadline is displayed on the display 710 of the information terminal 700. In this way, by looking at the recommendation image 713, the user is able to know that the update time (recommended deadline) is close. For this reason, the server apparatus 600 is able to effectively encourage the user to transmit status information about the storage battery pack 200 to the server apparatus 600 by the recommended deadline.

### Other Embodiments

As above, embodiments have been described as illustrative examples of the technology disclosed in the present application. However, the technology according to the present disclosure is not limited thereto, and is also applicable to embodiments obtained by making appropriate modifications, substitutions, additions, removals, and the like. Furthermore, the respective structural elements described in the foregoing embodiments may also be combined to form new embodiments.

In addition, the communication between the apparatuses described in the foregoing embodiment may be wireless communication or wired communication. Also, the communication standard is not particularly limited. For wireless communication between apparatuses, the IEEE 802.15.1 standard, which is an international standard for short-range wireless communication as typified by Bluetooth (registered trademark), may be used. Also, for wireless communication between apparatuses, the IEEE 802.11 standard, which is an international standard for wireless communication as typified by a wireless local area network (LAN) or Wi-Fi (registered trademark), may be used. Also, for wired communication between apparatuses, the IEEE 802.3 standard, which is an international standard for wired communication as typified by wired LAN, may be used.

Additionally, in the foregoing embodiments, each structural element may be configured by dedicated hardware, or realized by executing a software program suited to each structural element. Each structural element may be realized as a result of a program executor such as a CPU or processor reading out and executing a software program recorded on a recording medium such as a hard disk or semiconductor memory.

Also, in the foregoing embodiments, each structural element may also be a circuit. Multiple structural elements may constitute a single circuit as a whole, or may constitute respectively different circuits. Also, each circuit may be a general-purpose circuit or a special-purpose circuit.

The foregoing thus describes a control method of a server apparatus and a server apparatus according to one or multiple aspects on the basis of the embodiments, but the present disclosure is not limited to the embodiments. Embodiments obtained by applying various modifications that may occur to persons skilled in the art to the embodiments, as well as embodiments constructed by combining structural elements from different embodiments, may also be included in the scope of the one or multiple aspects insofar as such embodiments do not depart from the gist of the present disclosure.

For example, in the foregoing embodiments, a process executed by a specific structural element may also be executed by a different structural element instead of the specific structural element. Also, the order of the multiple processes may be modified, and multiple processes may also be executed in parallel.

The present disclosure is usable in a server apparatus that manages storage battery packs, and is applicable to technologies such as a storage battery pack lending system and a storage battery pack management system.

What is claimed is:

1. A server apparatus, comprising:
a communicator that communicates with a charging apparatus for a storage battery pack or an information terminal; and
a controller, wherein
when the communicator acquires information indicating a status of the storage battery pack from the charging apparatus or the information terminal by a recommended deadline that is recommended to manage the status of the storage battery pack, compared to when the communicator does not acquire the information indicating the status of the storage battery pack by the recommended deadline, the controller makes an adjustment including at least one of
i) discounting a usage fee for the storage battery pack, and
ii) increasing points which may be used to pay the usage fee by a user of the storage battery pack.

2. The server apparatus according to claim 1, wherein
when the communicator acquires the information indicating the status of the storage battery pack by the recommended deadline, the controller decreases the usage fee.

3. The server apparatus according to claim 1, wherein
when the communicator does not acquire the information indicating the status of the storage battery pack by the recommended deadline, the controller increases the usage fee.

4. The server apparatus according to claim 1, wherein
when the communicator acquires the information indicating the status of the storage battery pack by the recommended deadline, the controller confers the points.

5. The server apparatus according to claim 1, wherein
when the communicator acquires the information indicating the status of the storage battery pack by the recommended deadline, the controller reduces the points.

6. The server apparatus according to claim 1, wherein
the controller transmits information indicating the recommended deadline to the charging apparatus via the communicator.

7. The server apparatus according to claim 1, wherein
the controller transmits, to the information terminal of the user of the storage battery pack via the communicator, information encouraging the user to transmit the information indicating the status of the storage battery pack to the server apparatus.

8. A control method of a server apparatus, comprising:
acquiring information indicating a status of a storage battery pack from a charging apparatus for the storage battery pack or an information terminal; and
when information indicating the status of the storage battery pack is acquired by a recommended deadline that is recommended to manage the status of the storage battery pack, compared to when the information indicating the status of the storage battery pack is not acquired by the recommended deadline, making an adjustment including at least one of
discounting a usage fee for the storage battery pack, and
increasing points which may be used to pay the usage fee by a user of the storage battery pack.
